(19) United States
(12) Patent Application Publication
(10) Pub. No.: US 2019/0389198 A1
(43) Pub. Date: Dec. 26, 2019

(54) TRANSFER FILM AND IMAGE FORMING METHOD

(71) Applicant: FUJIFILM Corporation, Tokyo (JP)

(72) Inventors: Hideki KAIMOTO, Fujinomiya-shi (JP); Hiroshi KAWAKAMI, Fujinomiya-shi (JP)

(73) Assignee: FUJIFILM Corporation, Tokyo (JP)

(21) Appl. No.: 16/562,273

(22) Filed: Sep. 5, 2019

Related U.S. Application Data
(63) Continuation of application No. PCT/JP2018/009412, filed on Mar. 12, 2018.

(30) Foreign Application Priority Data
Mar. 13, 2017 (JP) 2017-047090

(51) Int. Cl. B41J 2/005; B41M 5/025

(52) U.S. Cl. CPC B41J 2/0057; B41M 5/0256

(57) ABSTRACT

An object is to provide a transfer film having a support, a protective layer, an image receiving layer, and an ink permeation layer, in which the support can be suitably peeled off after the transfer film is caused to adhere to a printing material, and interference fringes can be suppressed in a case where an image is observed, and an image forming method using this transfer film. The transfer film has the support, the protective layer that is formed on one surface of the support, the image receiving layer that is formed on a surface of the protective layer, and the ink permeation layer that is formed on a surface of the image receiving layer, in which the protective layer contains a polymer having a glass transition temperature of 0° C. or higher and a cellulose nanofiber.

### CROSS-REFERENCE TO RELATED APPLICATIONS

This application is a Continuation of PCT International Application No. PCT/JP2018/009412 filed on Mar. 12, 2018, which claims priority under 35 U.S.C. § 119(a) to Japanese Patent Application No. 2017-047090 filed on Mar. 13, 2017. The above application is hereby expressly incorporated by reference, in its entirety, into the present application.

### BACKGROUND OF THE INVENTION

### 1. Field of the Invention

The present invention relates to a transfer film capable of receiving an image printed by ink jet and transferring an image receiving layer (ink receiving layer) to a transferred medium, and an image forming method using the transfer film.

### 2. Description of the Related Art

Since an inkjet method is capable of performing printing at high speed with a simple mechanism, the method has been widely used and it has been attempted to perform printing not only on paper but also on various articles such as cloth or fabric as a printing material.

Along with that, in recent years, it has been required to perform printing on a printing material which has a low ink holding capacity and to which an ink does not easily adhere to, such as a member which does not have an ink holding capacity and to which an ink does not easily adhere to, for example, a surface of a compact disc (CD) or a digital versatile disc (DVD), a surface of a resin molded product, a surface of a metal product, or a product formed of coated cardboard or corrugated board with low glossiness, by ink jet.

For a method of performing printing by ink jet on such a printing material having a low ink receiving capacity, JP2002-321442A discloses a film in which an image receiving layer and an adhesive layer are laminated (ink jet receiving layer transfer film).

In the film described in JP2002-321442A, the image receiving layer is formed on the surface of the printing material by bonding the film to the printing material with the adhesive layer, and printing is performed on the image receiving layer formed on the printing material by an ink jet method. Thus, it is possible to perform printing on the printing material having a low ink receiving capacity by an ink jet method.

In contrast, in the film described in JP2002-321442A, after the image receiving layer is formed on the printing material by bonding the film to the printing material, printing is performed. Therefore, in the printing on the printing material using the film, it is necessary to complicate the ink jetting direction and the transportation of the printing material according to the shape of the printing material at printing.

As a transfer film for solving such a problem, a transfer film described in JP5864160B is known.

The transfer film described in JP5864160B includes an ink permeation layer which has a jetting surface by an ink jet method, has voids for allowing permeation of an ink from the jetting surface, and is charged to the same polarity as the polarity of the ink so as to promote permeation of the ink in the voids, an image receiving layer (ink receiving layer) which receives the ink that has passed through the ink permeation layer, and a supporting and protective layer which is positioned on the opposite side of the ink permeation layer with the image receiving layer sandwiched therebetween, supports the ink permeation layer and the image receiving layer, and protects the image receiving layer and the ink permeation layer.

In the transfer film, the ink permeation layer also functions as a pressure sensitive adhesive layer for heating and causing the transfer film to adhere to the printing material. In addition, in a preferable aspect of this transfer film, the supporting and protective layer is divided into a protective layer which protects the ink permeation layer and the image receiving layer, and a support which supports the ink permeation layer and the image receiving layer.

In a case where printing is performed on the printing material using the transfer film described in JP5864160B, printing is performed on the transfer film from the jetting surface of the ink permeation layer by an ink jet method and the printed image is received and held in the image receiving layer. Next, by causing the jetting surface of the ink permeation layer to abut on the printing material and heating the transfer film, the transfer film (ink permeation layer) and the printing material are heated and caused to adhere to each other.

Finally, a laminate including the ink permeation layer, the image receiving layer, and the protective layer is transferred to the printing material by peeling off the support from the transfer film, and thus an image is formed on the printing material by the ink jet method (refer to FIG. 7).

### SUMMARY OF THE INVENTION

According to the transfer film described in JP5864160B, printing is performed on the sheet-like transfer film by an ink jet method in advance, then the transfer film is heated and caused to adhere to the printing material, and the support is peeled off. Thus, an image is formed on the printing material by ink jet. Therefore, regardless of the shape of the printing material, printing can be performed by the same printing method as a usual ink jet method for an ink jet image receiving paper or the like.

In addition, since this transfer film has an ink permeation layer different from the image receiving layer and the transfer film (the laminate including the ink permeation layer, the image receiving layer, and the protective layer) is caused to adhere to the printing material by this ink permeation layer, the image receiving layer which holds the image is not affected by adhesion. Therefore, a high quality image can be formed on the printing material.

However, not only in the transfer film described in JP5864160B, but also in a transfer film, which has a support, a protective layer, an image receiving layer, and an ink permeation layer, is caused to adhere to a printing material after printing is performed by an ink jet method, and from which the support is peeled off, there arise problems such that the support cannot be peeled off due to poor peelability between the support and the protective layer, the image receiving layer is peeled off from the protective layer, or the protective layer is not formed on the image receiving layer due to the cohesively broken image receiving layer, and the laminate including the ink permeation layer, the image receiving layer, and the protective layer transferred by peeling off the support reaches the outside of the printing material, and thus the transfer to the printing material cannot be appropriately performed in many cases.

In addition, in the laminate including the ink permeation layer, the image receiving layer, and the protective layer, which adheres to the printing material and from which the support is peeled off, the protective layer side becomes an image observation surface. In this laminate, it is required to satisfactorily observe the image held by the image receiving layer.

However, in a case where the image of the laminate in which a support is peeled off from a transfer film in the related art is observed, depending on the kind of illumination, interference fringes may be observed, and there are cases where the image held by the image receiving layer cannot be observed satisfactorily. For example, in a case where the image of the laminate obtained by peeling off the support from the transfer film is observed with a light source with many short wavelength components such as a fluorescent lamp, thinly colored (for example, green and orange) fringes such as a state in which oil floats on water may be observed, and the image held by the image receiving layer may not be observed satisfactorily in some cases.

Therefore, in such a transfer film, the appearance of a transfer film which is excellent in the peelability of the support and which has few interference fringes generated in a case where the image is observed is desired.

The object of the present invention is to solve such problems in the related art and is to provide a transfer film in which a support can be appropriately peeled off after printing is performed by an ink jet method and the transfer film is caused to adhere to a printing material, and few interference fringes are generated in a case where an image is observed, and an image forming method using this transfer film.

In order to achieve the object, the present invention provides a transfer film comprising: a support; a protective layer that is formed on one surface of the support; an image receiving layer that is formed on a surface of the protective layer; and an ink permeation layer that is formed on a surface of the image receiving layer and has voids for allowing permeation of an ink, in which the protective layer contains a polymer having a glass transition temperature of 0° C. or higher and a cellulose nanofiber.

In such a transfer film according to the present invention, it is preferable that an average fiber diameter of the cellulose nanofiber is 50 nm or less.

In addition, it is preferable that a content of the cellulose nanofiber in the protective layer is 0.06% by mass or more.

Further, it is preferable that the protective layer further contains inorganic particles.

According to the present invention, there is also provided an image forming method comprising:

a printing step of performing printing on the transfer film according to the embodiment of the present invention from the ink permeation layer by an ink jet method;

an adhering step of causing the ink permeation layer of the transfer film subjected to printing to abut on a printing material and heating and causing the transfer film to adhere to the printing material; and

a peeling step of peeling off the support from the transfer film adhering to the printing material.

In such an image forming method according to the present invention, it is preferable that the transfer film is long, and the adhering step and the peeling step are performed while the long transfer film and the printing material are being transported in a longitudinal direction of the long transfer film at a same speed.

In addition, it is preferable that a transport path of the long transfer film has an approaching region which is directed in a direction in which the transfer film approaches the printing material, and a separating region which is provided on a downstream side of the approaching region and is directed in a direction in which the transfer film is separated from the printing material, the adhering step is performed between the approaching region and the separating region, and the peeling step is performed in the separating region.

In addition, it is preferable that the printing step is performed on an upstream side from a region in the adhering step in a transport direction of the long transfer film, while the long transfer film is being transported in the longitudinal direction.

Further, it is preferable that printing is performed on the ink permeation layer using one or more of a white inorganic pigment, organic resin fine particles, and light scattering particles by an ink jet method on a downstream side from a region in the printing step in the transport direction of the long transfer film and on the upstream side from a region in the adhering step, while the long transfer film is being transported in the longitudinal direction.

According to the present invention, it is possible to realize a transfer film in which a support can be appropriately peeled off after printing is performed by an ink jet method and the transfer film is caused to adhere to a printing material, and few interference fringes are generated in a case where an image is observed, and an image forming method capable of forming a high quality image on a random printing material using this transfer film.

### BRIEF DESCRIPTION OF THE DRAWINGS

FIG. 1 is a view conceptually showing an example of a transfer film according to the present invention.

FIG. 2 is a view conceptually showing an image receiving layer of the transfer film shown in FIG. 1.

FIG. 3 is a view conceptually showing an ink permeation layer of the transfer film shown in FIG. 1.

FIG. 4 is a view conceptually showing an example of an image forming apparatus for carrying out an image forming method according to the present invention.

FIG. 5 is a view conceptually showing another example of the image forming apparatus for carrying out the image forming method according to the present invention.

FIG. 6 is a view conceptually showing image formation using a transfer film of the related art.

FIG. 7 is a view conceptually showing image formation using the transfer film of the related art.

### DESCRIPTION OF THE PREFERRED EMBODIMENTS

Hereinafter, a transfer film and an image forming method according to suitable embodiments of the present invention will be described in detail based on the attached drawings.

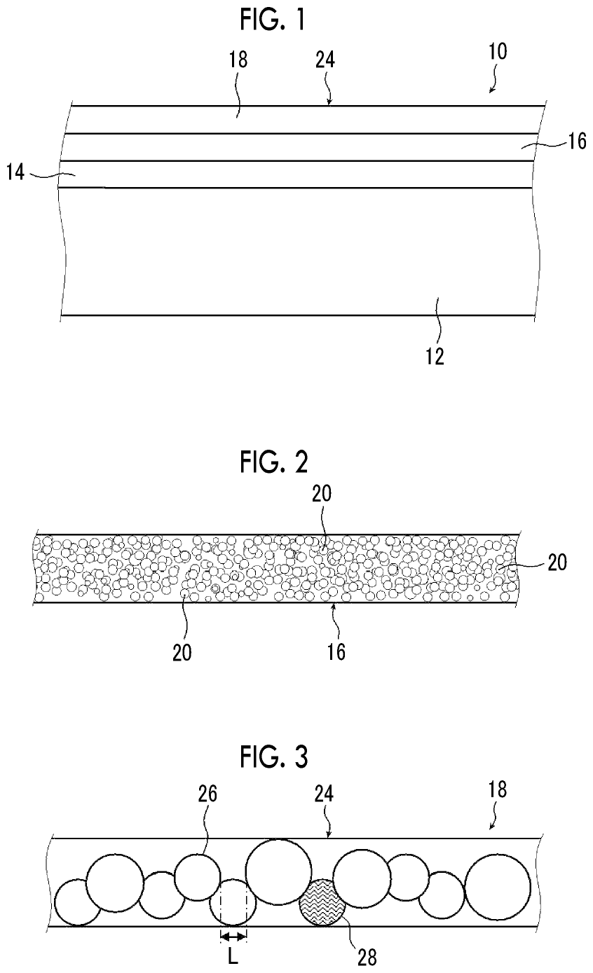

FIG. 1 is a view conceptually showing an example of a transfer film according to an embodiment of the present invention.

As shown in FIG. 1, a transfer film 10 according to an embodiment of the present invention has a support 12, a protective layer 14 that is formed on one surface of the support 12, an image receiving layer 16 that is formed on a surface of the protective layer 14, and an ink permeation layer 18 that is formed on a surface of the image receiving layer 16.

Although described in detail later, after printing (letter printing, drawing) is performed on the transfer film from the ink permeation layer 18 by an ink jet method, the transfer film 10 is caused to adhere to the printing material P by heating and causing the ink permeation layer 18 to adhere to an article which becomes a printing material P, and then the support 12 is peeled off from the protective layer 14. Thus, a laminate including the ink permeation layer 18, the image receiving layer 16, and the protective layer 14 is transferred to the printing material P and an image is formed on the article which becomes a printing material P.

Accordingly, in a state in which the laminate including the ink permeation layer 18, the image receiving layer 16, and the protective layer 14 is transferred to the printing material P, the protective layer 14 becomes a surface and the ink permeation layer 18 becomes a layer close to the printing material P. That is, in a state in which a laminate is transferred to the printing material P, the protective layer 14 side is an image observation surface.

In the following description, the laminate including the ink permeation layer 18, the image receiving layer 16, and the protective layer 14, in which after the transfer film 10 is caused to adhere to the printing material P, the support 12 is peeled from the transfer film 10, is simply referred to as “transfer laminate”.

The support 12 supports the protective layer 14, the image receiving layer 16, and the ink permeation layer 18 until the transfer film 10 is caused to adhere to the printing material P.

For the support 12, various sheet materials (films) can be used as long as the material can support the protective layer 14, the image receiving layer 16, and the ink permeation layer 18, and has sufficient heat resistance with respect to heating and adhesion of the printing material P, which will be described later, and the ink permeation layer 18.

Examples of the support 12 include resin films formed of various resin materials. Specific examples of the resin materials used to form the support 12 include polyester resins such as polyethylene terephthalate (PET) and polyethylene naphthalate (PEN), polycarbonate resins, (meth)acrylic resins, and polyimide resins.

The thickness of the support 12 is not particularly limited and the thickness at which the protective layer 14, the image receiving layer 16, and the ink permeation layer 18 can be supported until the printing material P, which will be described later, and the ink permeation layer 18 are heated and caused to adhere to each other and peeling can be appropriately performed without causing breakage after the transfer film 10 is caused to adhere to the printing material P, may be appropriately set according to the forming material or the like.

The thickness of the support 12 is preferably 20 to 200 μm and more preferably 50 to 130 μm.

The protective layer 14 is formed on one surface of the support 12.

The protective layer 14 is a layer which protects the image receiving layer 16 holding an image formed by an ink jet method after the transfer film 10 is caused to adhere to the printing material P and the support 12 is peeled off.

Here, in the transfer film 10 according to the embodiment of the present invention, the protective layer 14 contains a polymer having a glass transition temperature (Tg) of 0° C. or higher and a cellulose nanofiber. In the following description, the term “cellulose nanofiber” is also referred to as “CNF”.

Since the transfer film 10 according to the embodiment of the present invention has such a protective layer 14, the peelability between the support 12 and the protective layer 14 is good and interference fringes generated in a case where the image held by the image receiving layer 16 is observed after the transfer film 10 is caused to adhere to the printing material P and the support 12 is peeled off can be remarkably reduced.

As described above, as a transfer film which makes printing possible with an ink jet method using an article of an arbitrary shape as a printing material, as disclosed in JP5864160B, a transfer film formed by laminating a support, a protective layer, an image receiving layer, and an ink permeation layer is known.

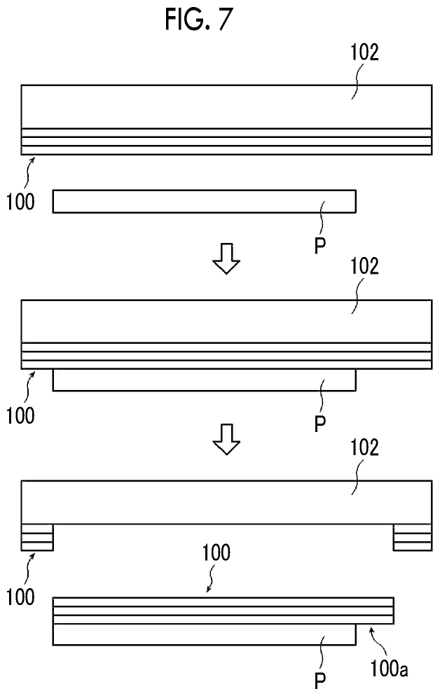

As described above, after printing is performed on the transfer film from the ink permeation layer by an ink jet method, as conceptually shown in FIG. 7, the transfer film (ink permeation layer) and the printing material P are heated and caused to adhere to each other and a support 102 is peeled off from the protective layer so that a laminate 100 including the ink permeation layer, the image receiving layer, and the protective layer is transferred to the printing material P to form an image on the printing material P by the ink jet method.

However, in the case of the transfer film in the related art, there are defects that the peelability between the support 102 and the protective layer is not sufficient, the support 102 cannot be appropriately peeled off, the image receiving layer is peeled off from the protective layer or cohesion failure of the image receiving layer occurs, the protective layer is not formed on the image receiving layer, and the like. Further, depending on the cases, as conceptually shown by reference numeral 100a in the lower part of FIG. 7, problems occur such as transfer of an extra laminate 100a in a region over the printing material P. In the following description, the transfer of the extra laminate 100a to the printing material P is also referred to as “wing attachment” for convenience.

In addition, in the transfer film in the related art, in a case where after the transfer film and the printing material P are heated and caused to adhere to each other and the support 102 is peeled off from the protective layer, the image held by the image receiving layer is observed from the protective layer side, depending on the kind of illumination, that is, the observation light, as described above, interference fringes such as colored streaks generated in a case where oil floating in water is observed are generated (interference fringes are observed).

In a case where such interference fringes are generated, the visibility of the image held by the image receiving layer is deteriorated, and it becomes difficult to achieve good image observation.

In contrast, in the transfer film 10 according to the embodiment of the present invention, since the protective layer 14 contains a polymer having a glass transition temperature (Tg) of 0° C. or higher, and CNF, transfer of the protective layer 14 to the support 12 or the like is prevented and the support 12 is appropriately peeled off from the protective layer 14, so that the transfer laminate can be transferred to the printing material P. That is, in the transfer film 10 according to the embodiment of the present invention, in a normal state, the support 12 and the protective layer 14 are caused to adhere to each other with sufficient adhesion, and in a case where the force for peeling the support 12 and the protective layer 14 is applied, the support 12 and the protective layer 14 can be suitably peeled.

In addition, according to the transfer film 10 according to the embodiment of the present invention, since the protective layer 14 contains CNF, after the transfer laminate is transferred to the printing material P, interference fringes generated in a case where the image is observed can be reduced, and the image held by the transfer laminate (image receiving layer 16) can be suitably observed.

As described above, the transfer laminate is a laminate including the ink permeation layer 18, the image receiving layer 16 and the protective layer 14, which is obtained by causing the transfer film 10 to adhere to the printing material P, and then peeling off the support 12 from the transfer film.

In general, it is known that the adhesiveness between the resin film which becomes the support and a layer to be formed thereon which is formed of a polymer becomes stronger as the solubility parameters of each material constituting the resin film and the layer formed of a polymer become closer to each other.

However, according to the study of the present inventors, by increasing the glass transition temperature of the polymer contained in the protective layer 14 to be formed on the surface of the support 12, regardless of the solubility parameter of the polymer, the peelability between the support 12 and the protective layer 14 can be improved. In particular, the tendency becomes stronger in a case where the protective layer 14 is formed of a latex-based material (aqueous dispersion).

In addition, as described later in the examples, since the protective layer 14 contains CNF, the peelability between the support 12 and the protective layer 14 can be improved according to the content of CNF.

That is, since the protective layer 14 in the transfer film 10 according to the embodiment of the present invention contains the polymer having a glass transition temperature of 0° C. or higher and CNF, due to the synergistic effect of the polymer having a glass transition temperature of 0° C. or higher and CNF, the peelability between the support 12 and the protective layer 14 can be made satisfactory, and the generation of defects that the support 12 cannot be appropriately peeled off and the like is suppressed. Thus, it is possible to appropriately peel the support 12 and the protective layer 14. In addition, since the protective layer 14 contains the polymer having a glass transition temperature of 0° C. or higher, the scratch resistance of the protective layer 14 can be increased.

Here, the film formed of the polymer is highly transparent and homogeneous. Therefore, in a case of observing the image carried by the image receiving layer of the transfer laminate including the ink permeation layer, the image receiving layer and the protective layer after the support is peeled off from the transfer film, depending on the kind of illumination, there is a problem that interference fringes are generated as described above.

In contrast, in the transfer film 10 according to the embodiment of the present invention, since the protective layer 14 contains CNF as well as the polymer, interference fringes can be suppressed.

In a case where the image held by the image receiving layer 16 is observed in a state in which the transfer laminate is transferred to the printing material P, the protective layer 14 side becomes an observation surface.

In the image observation of such a laminate, it is considered that the main cause of the generation of interference fringes is a difference in refractive index between the protective layer 14 to be the observation surface and the image receiving layer 16 holding the image.

In contrast, in the transfer film 10 according to the embodiment of the present invention, the protective layer 14 contains CNF. Since the protective layer 14 contains, in addition to the polymer, CNF having a refractive index (the refractive index is around 1.57) different from the refractive index of the polymer (for example, the refractive index of polyurethane is around 1.54), it is considered that the optical homogeneity of the polymer is reduced to cause light refraction at the interface between the polymer and CNF, whereby the generation of interference fringes due to a difference in refractive index between the protective layer 14 and the image receiving layer 16 can be suppressed.

In addition, since CNF is very fine, CNF is hard to be recognized by human eyes. For example, since CNF is very fine with a fiber diameter of 100 nm or less, and preferably an average fiber diameter of 50 nm or less, CNF is hard to be recognized by human eyes. Therefore, the transfer film 10 (transfer laminate) according to the embodiment of the present invention can sufficiently ensure the transparency of the protective layer 14 to be the observation surface.

In the transfer film 10 according to the embodiment of the present invention, the glass transition temperature of the polymer contained in the protective layer 14 is 0° C. or higher, preferably 20° C. or higher, and more preferably 30° C. or higher. Thus, the peelability between the support 12 and the protective layer 14 can be further improved.

The upper limit of the glass transition temperature of the polymer having a glass transition temperature of 0° C. or higher is not particularly limited. Here, according to the study of the present inventors, the glass transition temperature of the polymer contained in the protective layer 14 is preferably 80° C. or lower.

By setting the glass transition temperature of the polymer contained in the protective layer 14 to 80° C. or lower, the formation of the protective layer 14 (film formation) can be suitably performed and the film forming temperature can be lowered. Thus, it is preferable to set the glass transition temperature to 80° C. or lower from the viewpoint that the selection range of the support 12 can be widened.

The glass transition temperature of the polymer may be measured by a known method or numerical values described in various documents may be used. In a case of using a commercially available polymer, a numerical value described in a catalog or the like may be used or a numerical value calculated from the composition of a polymer may be used. For example, as a method of measuring the glass transition temperature, a measurement method according to Japanese industrial standards (JIS) K 7121 using a differential scanning calorimetry may be used.

The solubility parameter (SP value) of the polymer having a glass transition temperature of 0° C. or higher contained in the protective layer 14 is preferably 8.5 (cal/cm³)^{1/2} or greater and more preferably 9.0 (cal/cm³)^{1/2} or greater.

By setting the solubility parameter of the polymer contained in the protective layer 14 to 8.5 (cal/cm³)^{1/2} or greater, the protective layer can be formed of a polymer having high polarity and a strong cohesive force. Thus, from the viewpoint that the scratch resistance of the protective layer 14 can be improved, the tensile strength of the protective layer 14 is high, and the peelability can be improved, it is preferable to set the solubility parameter to 8.5 (cal/cm³)^{1/2} or greater.

The solubility parameter of the polymer may be measured by a known method or and numerical values described in various documents may be used. In a case of using a commercially available polymer, a numerical value described in a catalog or the like may be used.

In addition, the SI unit of the solubility parameter is [(MPa)^{1/2}]. The unit [(cal/cm³)^{1/2}] can be converted to [(MPa)^{1/2}] which is the SI unit by multiplying by 2.05. That is, it is “[(MPa)^{1/2}]=[(cal/cm³)^{1/2}]×2.05”.

In the transfer film 10 according to the embodiment of the present invention, as the polymer contained in the protective layer 14, known various polymers can be used as long as the polymer has a glass transition temperature of 0° C. or higher.

Examples thereof include a urethane-based polymer, an acrylic polymer, a vinyl acetate-based polymer, a vinyl chloride-based polymer, a rubber-based polymer, a styrene-based polymer, a silicone-based polymer, an ester-based polymer, an amide-based polymer or a copolymer including a plurality of repeating units constituting these polymers. Among these, from the viewpoint of further excellent peelability of the support, a urethane-based polymer is preferable.

In addition, as the polymer having a glass transition temperature of 0° C. or higher, a commercially available product may be used.

Examples of the commercially available product of the polymer include SUPER FLEX 170 (urethane-based polymer), SUPER FLEX 820 (urethane-based polymer), SUPER FLEX 830HS (urethane-based polymer), and SUPER FLEX 870 (urethane-based polymer) manufactured by Dai-Ichi Kogyo Seiyaku Co., Ltd.; VINYBLAN 287 (vinyl chloride-acrylic polymer), VINYBLAN 900 (vinyl chloride-acrylic polymer), VINYBLAN 2684 (acrylic polymer), VINYBLAN 2685 (acrylic polymer), VINYBLAN 2687 (acrylic polymer), and VINYBLAN 715S (vinyl chloride-based polymer) manufactured by Nissin Chemical Industry Co., Ltd.; SUMIKAFLEX 752HQ (ethylene-vinyl acetate copolymer resin emulsion), SUMIKAFLEX 808HQ (ethylene-vinyl acetate-vinyl chloride copolymer resin emulsion), SUMIKAFLEX 850HQ (ethylene-vinyl acetate-vinyl chloride copolymer resin emulsion), and SUMIKAFLEX 830 (ethylene-vinyl acetate-vinyl chloride copolymer resin emulsion) manufactured by Sumika Chemitex Co., Ltd.; Nipol LX433C (styrene butadiene rubber), Nipol LX2507H (styrene butadiene rubber), Nipol LX416 (styrene butadiene rubber), Nipol LX814 (acrylic polymer), and Nipol LX855EX1 (acrylic polymer) manufactured by Zeon Corporation; and MOWINYL 742A (acrylic polymer), MOWINYL 1711 (acrylic polymer), MOWINYL 6520 (acrylic polymer), MOWINYL 7980 (acrylic polymer), MOWINYL 081F (vinyl acetate-ethylene-based copolymer), and MOWINYL 082 (vinyl acetate-ethylene-based copolymer) manufactured by The Nippon Synthetic Chemical Industry Co., Ltd.

A plurality of these polymers having a glass transition temperature of 0° C. or higher may be used in combination. That is, the protective layer 14 may contain two or more polymers having a glass transition temperature of 0° C. or higher.

Since the protective layer 14 contains two or more polymers, it is possible to obtain the transfer film 10 in which the transferability and scratch resistance of the protective layer is excellent by expressing the properties of the respective polymers. For example, by using a urethane-based polymer and an ethylene-vinyl acetate-vinyl chloride copolymer in combination, it is possible to obtain the transfer film 10 in which the peelability of the support 12 and the scratch resistance of the protective layer 14 are excellent.

The content of the polymer having a glass transition temperature of 0° C. or higher in the protective layer 14 is preferably 20% by mass or more, more preferably 30% by mass or more, and particularly preferably 50% by mass or more.

It is preferable to set the content of the polymer having a glass transition temperature of 0° C. or higher in the protective layer 14 to 20% by mass or more from the viewpoint that the peelability between the support 12 and the protective layer 14 can be improved, the scratch resistance of the protective layer 14 can be improved, and the bendability (flexibility) can be improved.

The protective layer 14 contains CNF in addition to such a polymer.

CNF is a cellulose microfibril having a fiber diameter (fiber width) of 100 nm or less, and preferably 20 nm or less, which is obtained by disintegrating a cellulose-based material.

As an example, such CNF can be obtained by dispersing a cellulose-based material (cellulose fiber) in water, then oxidizing the cellulose using 2,2,6,6-tetramethylpiperidine-1-oxy radical (TEMPO) or the like, and subjecting the oxidized cellulose to a wet type disintegration treatment using water or the like or performing disintegration by a phosphoric acid esterification method.

Examples of the cellulose-based material include various pulps (papers) such as kraft pulp and sulfite pulp derived from various woods, powdered cellulose obtained by grinding such pulp with a homogenizer or mill, and the like, and a microcrystalline cellulose powder obtained by purifying powdered cellulose by s chemical treatment such as acid hydrolysis. In addition, plants such as kenaf, hemp, rice, bagasse and bamboo can also be used as a cellulosic material.

A commercially available product can be suitably used as CNF.

Examples of the commercially available product of CNF include LEO crystal (manufactured by Dai-ichi Kogyo Seiyaku Co., Ltd.), BiNFi-s (manufactured by SUGINO MACHINE LIMITED.), CELISH (manufactured by Daicel FineChem Ltd.), and nanoforest (manufactured by Chuetsu Pulp & Paper Co., Ltd.).

In the transfer film 10 according to the embodiment of the present invention, the average fiber diameter of CNF contained in the protective layer 14 is preferably 50 nm or less, more preferably 20 nm or less, and even more preferably 10 nm or less.

It is preferable to set the average fiber diameter of CNF to 50 nm or less from the viewpoint that interference fringes can be suitably suppressed, the transparency of the protective layer can be improved, and the peelability can be improved.

The lower limit of the average fiber diameter of CNF is not particularly limited, but is usually 2 nm or more.

The average fiber diameter of CNF may be measured by a known method such as electron microscope observation, and the like. Further, in a case where a commercially available CNF is used, as the average fiber diameter of CNF, a catalog value may be used.

The fiber length of CNF is not particularly limited, but is preferably 0.5 to 200 μm, and more preferably 1 to 20 μm.

It is preferable to set the fiber length of CNF in this range from the viewpoint that the effect of reducing interference fringes can be suitably obtained and the transparency of the protective layer 14 can be made satisfactorily.

The content of CNF in the protective layer 14 is not particularly limited, but is preferably 0.06% by mass or more, more preferably 0.1% by mass or more, and even more preferably 0.2% by mass with respect to the total mass of the protective layer 14.

It is preferable to set the content of CNF in the protective layer 14 to 0.06% by mass or more from the viewpoint that the effect of reducing interference fringes can be suitably obtained and the peelability between the support 12 and the protective layer 14 can be improved.

The upper limit of the content of CNF in the protective layer 14 is not particularly limited, but is preferably 5% by mass or less, more preferably 2% by mass or less, and even more preferably 1% by mass or less with respect to the total mass of the protective layer 14.

It is preferable to set the content of CNF in the protective layer 14 to 5% by mass or less from the viewpoint that the transparency of the protective layer 14 can be increased.

As described above, the refractive index of CNF is 1.57. Here, it is preferable that the polymer having a glass transition temperature of 0° C. or higher included in the protective layer 14 and CNF have a difference in refractive index to some extent.

The protective layer 14 may contain inorganic particles in addition to the polymer having glass transition temperature of 0° C. or higher and CNF. Since the protective layer 14 contains inorganic particles, the effect of reducing interference fringes can be further improved. In addition, since the protective layer 14 contains inorganic particles, the effect of suppressing the generation of the above-mentioned wing attachment can also be obtained.

Various known inorganic particles can be used as the inorganic particles. Examples thereof include kaolin, aluminum hydroxide, clay, calcium carbonate, magnesium carbonate, barium sulfate, talc, calcined clay, calcined kaolin, titanium oxide, zinc oxide, diatomaceous earth, fine particulate anhydrous silica, and aluminum oxide (alumina). Among these, from the viewpoint that the sliding properties of the protective layer 14 can be improved, kaolin and aluminum hydroxide are suitably used.

The particle diameter of the inorganic particles is not particularly limited, but is preferably 0.05 to 5 μm, more preferably 0.1 to 2 μm, and still more preferably 0.2 to 1 μm.

It is preferable to set the particle diameter of the inorganic particles in this range from the viewpoint that the effect of reducing interference fringes can be improved, the transparency of the protective layer 14 can be made satisfactorily, and the sliding properties of the protective layer 14 can be improved.

Similar to the above-mentioned CNF, it is preferable that the polymer having a glass transition temperature of 0° C. or higher and the inorganic particles contained in the protective layer 14 have different refractive indexes. Specifically, a difference in refractive index between the polymer and the inorganic particles is preferably 0.01 to 0.1, more preferably 0.01 to 0.08, and even more preferably 0.01 to 0.06.

It is preferable to set the difference in refractive index between the polymer having a glass transition temperature of 0° C. or higher and the inorganic particles in the above range from the viewpoint that the effect of reducing interference fringes can be obtained satisfactorily and the transparency of the protective layer 14 can be increased.

In the transfer film 10, as the amount of the inorganic particles contained in the protective layer 14 increases, the effect of reducing interference fringes can be more suitably obtained. In contrast, as the content of the inorganic particles increases, the transparency of the protective layer 14 decreases. That is, the content of the inorganic particles contained in the protective layer 14 may be appropriately set according to the amount of generated interference fringes allowable in the transfer film 10 (the laminate from which the support is peeled off) and the transparency required for the protective layer 14.

In consideration of the above point, the content of the inorganic particles in the protective layer 14 is preferably 0.1% to 50% by mass, more preferably 1% to 35% by mass, and even more preferably 3% to 25% by mass with respect to the total mass of the protective layer 14.

The protective layer 14 may contain a surfactant, if necessary.

The protective layer contains a surfactant and thus the peelability between the support 12 and the protective layer 14 can be improved.

Examples of the surfactant include non-ionic surfactants such as ethers such as polyoxyethylene nonyl phenyl ether, polyoxyethylene octyl phenyl ether, polyoxyethylene dodecyl phenyl ether, polyoxyethylene oleyl ether, polyoxyethylene lauryl ethers, and polyoxyalkylene alkyl ethers (for example, EMULGEN series such as EMULGEN 108, 109P, and the like, manufactured by Kao Corporation, SOFTANOL EP-5035, 7085, and 9050, manufactured by NIPPON SHOKUBAI Co., Ltd., and PLURONIC L-31, L-34, and L-44 manufactured by ADEKA Corporation);

esters such as polyoxyethylene oleate, polyoxyethylene distearate, sorbitan laurate, sorbitan monostearate, sorbitan monooleate, sorbitan sesquioleate, polyoxyethylene monooleate, and polyoxyethylene stearate; and

polyglycol ethers such as polyoxyethylene acetylene glycol ether, polyoxyethylene distyrenated phenyl ether, and polyoxyethylene tribenzylated phenyl ether (for example, SURFYNOL 104, 104PG50, 105PG50, 82, 420, 440, 465, and 485, and OLFINE STG, manufactured by The Nippon Synthetic Chemical Industry Co., Ltd), and various known surfactants can be used according to the forming material of the protective layer 14. In addition, as the surfactant, a commercially available product may be used.

The content of the surfactant in the protective layer 14 is preferably 0.01% to 5% by mass and more preferably 0.1% to 2% by mass with respect to the total mass of the protective layer 14.

Further, if necessary, the protective layer 14 may contain various additives such as a wax, an ultraviolet absorber, an antioxidant, and the like other than CNF, the inorganic particles, and the surfactant.

The thickness of the protective layer 14 is not particularly limited and is preferably 6 μm or less.

Image formation is performed on the printing material P using the transfer film 10 according to the embodiment of the present invention by, in a state in which the ink permeation layer 18 of the transfer film 10 and the printing material P are caused to abut each other, heating and causing the ink permeation layer 18 to adhere to the printing material P and then peeling off the support 12, as described above.

In this case, in order to appropriately transfer a transfer laminate (a laminate including the ink permeation layer 18, the image receiving layer 16, and the protective layer 14) onto the printing material P, in a case where the support 12 is peeled off, it is necessary to break the transfer laminate. This breakage is performed by using the pressure sensitive adhesive force between the ink permeation layer 18 and the printing material P.

Here, in a case where the thickness of the protective layer 14 is too thick, the transfer laminate cannot be appropriately broken, the laminate adhering to the printing material P pulls the laminate of a region not adhering to the printing material P on the outside of the printing material P, and the extra laminate 100a on the outside of the printing material P is transferred to the printing material P. Thus, there is a possibility that the wing attachment as shown in FIG. 7 described above may be generated.

In contrast, by setting the thickness of the protective layer 14 to 6 μm or less, the transfer laminate is easily appropriately transferred to the end portion of the printing material P by using the pressure sensitive adhesive force between the ink permeation layer 18 and the printing material P. As a result, the generation of the wing attachment as shown in FIG. 7 described above is suppressed and thus the transfer laminate can be appropriately transferred to the printing material P. Particularly, in a case where the protective layer 14 contains the inorganic particles, the generation of the wing attachment can be more suitably prevented.

In consideration of this point, the thickness of the protective layer 14 is preferably 5 μm or less and more preferably 4 μm or less.

The lower limit of the thickness of the protective layer 14 is not particularly limited and the thickness at which the image receiving layer 16 can be sufficiently protected may be appropriately set according to the forming material of the protective layer 14.

The thickness of the protective layer 14 is preferably 1 μm or more and more preferably 2 μm or more. The protective layer 14 may have a single layer structure or a multilayer structure.

The image receiving layer 16 is formed on the surface of the protective layer 14. The image receiving layer 16 is a layer for holding an image by jetting an ink by an ink jet method and absorbing and fixing the ink permeated into the ink permeation layer 18.

The image receiving layer 16 is a layer formed of a polymer capable of receiving and swelling an aqueous ink, or a layer having voids (micropores) in which fine particles of an ink insoluble in a solvent (dispersion medium) are fixed by a binder. The aqueous ink is an ink containing water and/or a solvent soluble in water as a main component.

FIG. 2 is a view conceptually showing an example of the configuration of the image receiving layer 16.

The image receiving layer 16 shown in FIG. 2 is formed by fixing a plurality of ink receiving particles 20 insoluble in an ink by a binder and the ink is received in each gap of the ink receiving particles 20.

For the ink receiving particles 20, ink receiving particles which do not cause aggregation with a fixing agent for fixing a coloring material in an ink between the ink receiving particles 20 can be selected, and for example, ink receiving particles with nonpolarity or low polarity are selected. For example, as the ink receiving particles 20, polymer fine particles such as polyolefin, acryl, polystyrene, and polyester fine particles, and inorganic fine particles such as calcium carbonate, kaolin, aluminum silicate, calcium silicate, colloidal silica, alumina, and aluminum hydroxide fine particles can be used.

On the other hand, as a binder for fixing the ink receiving particles 20, gelatin, polyvinyl alcohol, polyvinyl pyrrolidone, alginic acid, aqueous polyester, and a water-soluble polymer such as an aqueous acrylic resin can be used.

In a case where the image receiving layer 16 for holding the coloring material in the ink has an own optical scattering function, the coloring intensity of the coloring material is lowered, and thus an image with low contrast is formed. Therefore, it is preferable that the image receiving layer 16 transparent without causing light scattering.

In consideration of this point, in order to suppress light scattering and light absorption and make the image receiving layer 16 transparent, as the ink receiving particles 20, it is preferable to use ink receiving particles which are colorless and has a particle size smaller than the wavelength of visible light or which is colorless and has a refractive index difference with the binder for fixing the ink receiving particles 20 of 0.1 or less. As a combination in which the refractive index difference between the ink receiving particles 20 and the binder is 0.1 or less, for example, a combination in which silica is used as the ink receiving particles 20 and polyvinyl alcohol (PVA) is used as the binder is exemplified.

It is preferable that the image receiving layer 16 fixes the coloring material of the ink to the surfaces of the ink receiving particles 20 so as not to be moved.

Therefore, it is preferable that the surfaces of the ink receiving particles 20 are treated to have a polarity opposite to the polarity of the coloring material of the ink. For example, by forming a fixing agent having a polarity opposite to the polarity of the coloring material of the ink to form the image receiving layer 16, the image receiving layer 16 can be charged to a polarity opposite to the polarity of the ink.

As such a fixing agent, in a case where the ink contains an anionic coloring material, a fixing agent having a primary amino group a secondary amino group, a tertiary amino group, or a quaternary ammonium group, such as dicyandiamide, diethylenetriamine, dimethylamine and diallyldimethylammonium chloride having a cationic polarity, can be used. On the other hand, in a case where the ink contains a cationic coloring material, an anionic fixing agent, for example, a water-soluble polymer or water dispersible polymer having a structure having carboxylic acid, sulfonic acid, phosphoric acid, or the like, as a hydrophilic group, can be used. As a fixing agent having such a structure, specifically, sodium salts such as animal and vegetable fat and fatty acid, alkylbenzene sulfonic acid, and alkyl naphthalene sulfonic acid, potassium salts and the like are exemplified.

The thickness of the image receiving layer 16 is not particularly limited and the thickness at which an image formed by jetting an ink by an ink jet method can be appropriately held may be appropriately set according to the forming material of the image receiving layer 16 such as the ink receiving particles 20.

The thickness of the image receiving layer 16 is preferably 5 to 50 μm and more preferably 10 to 40 μm. The image receiving layer 16 may have a single layer structure or a multilayer structure.

On the surface of the image receiving layer 16, the ink permeation layer 18 is provided.

The ink permeation layer 18 is a layer having a jetting surface 24 on which an ink is jetted to the surface by an ink jet method and voids for allowing permeation of the jetted ink to reach the image receiving layer 16. In addition, after printing is performed on the transfer film 10, the ink permeation layer 18 functions as a pressure sensitive adhesive layer (adhesive layer or pressure sensitive adhesive layer) for heating and causing the transfer film 10 to adhere to the printing material P.

FIG. 3 conceptually shows the configuration of the ink permeation layer 18.

In the ink permeation layer 18 shown in FIG. 3, the voids for allowing permeation of the ink are formed by gaps L of a plurality of thermoplastic resin particles 26 which are dispersed over the entire layer. Each gap L formed by the thermoplastic resin particles 26 is formed continuously in a thickness direction and thus the voids penetrating the ink permeation layer 18 in the thickness direction are formed. In the ink permeation layer 18, the ink jetted to the jetting surface 24 passes through the voids penetrating the ink permeation layer in the thickness direction and thus the ink passes through the ink permeation layer 18 and supplied to the image receiving layer 16.

In the ink permeation layer 18, it is preferable that the gap L (inter-particle distance) between the thermoplastic resin particles 26 is controlled to be 0.1 μM or more by selecting the particle size and particle distribution of the thermoplastic resin particles 26 or the like not to prevent permeation of the ink.

In addition, in the ink permeation layer 18, it is preferable that the particle size of the thermoplastic resin particle 26 is 0.1 to 10 μm so as not to prevent permeation of the ink and not to diffuse the ink in a direction parallel with the principal surface of the transfer film 10.

Further, the thermoplastic resin particles 26 is preferably formed of a material having a softening temperature of 40° C. to 100° C. so as not to prevent permeation of the ink at environmental temperature such as room temperature while the transfer film 10 is thermally bonded to the printing material P.

As such a material, for example, a styrene copolymer resin of styrene, acryl, and butadiene, or the like, a polyolefin-based resin, a resin formed of polymethacrylic acid and a derivative thereof, an acrylic ester-based resin, a polyacrylamide-based resin, a polyester-based resin, and a polyamide-based resin can be used.

The ink permeation layer 18 is preferably charged to the same polarity as the polarity of the ink so as to promote permeation of the ink in the voids. For example, by dispersing the thermoplastic resin particles 26 forming the voids using a charge control agent having the same polarity as the polarity of the coloring material in the ink, the ink permeation layer 18 can be charged to the same polarity as the polarity of the ink.

As the charge control agent, in a case where the ink contains an anionic coloring material such as an acidic dye, and in a case where the ink has a pigment dispersion that is charged with an anionic surfactant, a charge control agent with an anionic polarity is used. That is, as the anionic charge control agent, an anionic charge control agent of which the ions become negative ions when dissociated in water is used and for example, those having a carboxylic acid, sulfonic acid, or a phosphoric acid structure as a hydrophilic group are used. Specifically, as a carboxylic acid-based charge control agent, a fatty acid salt included soap as a main component, cholate, or the like can be used, as a sulfonic acid-based charge control agent, linear sodium alkylbenzene sulfonate, sodium lauryl sulfate, monoalkyl sulfate, alkyl polyoxyethylene sulfate, or the like can be used, and as a charge control agent having a phosphoric acid structure, monoalkyl phosphate or the like can be used.

On the other hand, in a case where the ink contains a cationic coloring material such as an alkaline dye, a cationic charge control agent is used. That is, as the cationic charge control agent, a cationic charge control agent of which the ions become positive ions when dissociated in water is used, and for example, those having tetraalkylammonium as a hydrophilic group are used. Specifically, an alkyltrimethylammonium salt, dialkyldimethylammonium salt, an alkylbenzyldimethylammonium salt and the like can be used.

Further, it is preferable that in the ink permeation layer 18, tackifier particles 28 (tackifying resin particles 28) for improving adhesion to the printing material P are included in a dispersed manner.

As the material constituting the tackifier particles 28, rosins, rosin esters, alicyclic resins, phenol resins, chlorinated polyolefin resins and the like can be used. Incidentally, the tackifier can also be contained inside the thermoplastic resin particles 26 without being dispersed in the ink permeation layer 18 as particles. By incorporating the tackifier into the thermoplastic resin at the time of thermal transfer, it is possible to strengthen the adhesion with the printing material.

As described above, the ink permeation layer 18 is disposed closer to the printing material P than to the image receiving layer 16 which carries the image in a state in which the transfer film 10 is transferred to the printing material P. That is, in a case where the image formed on the printing material P by the transfer film 10 is appreciated, the ink permeation layer 18 becomes an underlayer of the image receiving layer 16 which holds the image.

Therefore, for example, the ink permeation layer 18 may be formed as a white layer or light scattering layer by mixing organic resin fine particles formed of a white inorganic pigment, white polycarbonate, and a (meth)acrylic resin, light scattering particles, or the like with the ink permeation layer 18. Thus, regardless of the color of the printing material P to which the transfer film 10 is transferred, the visibility and sharpness of the image by the ink can be improved.

The thickness of the ink permeation layer 18 is not particularly limited and the thickness which allows the ink jetted by the ink jet method to appropriately permeate into the image receiving layer 16 and allows heating and adhesion with the printing material P with sufficient adhesion may be appropriately set according to the forming material of the ink permeation layer 18 such as the thermoplastic resin particles 26 or the like.

The thickness of the ink permeation layer 18 is preferably 0.1 to 5 μm and more preferably 0.2 to 3 μm. The ink permeation layer 18 may have a single layer structure or a multilayer structure.

Such a transfer film 10 according to the embodiment of the present invention can be prepared by a known method according to the forming material of each layer.

As an example, a resin film which becomes the support 12 is prepared.

On the other hand, a coating liquid for forming a protective layer 14 obtained by dissolving or dispersing a compound and CNF, which mainly form the protective layer 14, such as a polymer having a glass transition temperature of 0° C. or higher, CNF, or the like, in ion exchange water or the like is prepared.

In addition, as an example, a coating liquid for forming the protective layer 14 may be prepared by preparing a CNF dispersion liquid obtained by dispersing CNF in ion exchange water or the like, putting the prepared CNF dispersion liquid, the polymer having a glass transition temperature of 0° C. or higher, and the like into ion exchange water or the like, and homogeneously mixing these materials.

In a case of using a commercially available CNF product, CNF may be provided in the form of gel or slurry-like CNF aqueous dispersion. In this case, by adding ion exchange water or the like to the gel or slurry-like CNF aqueous dispersion and performing stirring to be homogeneous, the CNF dispersion liquid may be prepared. Alternatively, the gel or slurry-like CNF aqueous dispersion may be used as a CNF dispersion liquid as it is.

In addition, a coating liquid for forming an image receiving layer 16 obtained by dissolving or dispersing a compound, which becomes the image receiving layer 16, such as the ink receiving particles 20 such as silica particles, and a binder, in ion exchange water or the like, is prepared.

Further, a coating liquid for forming an ink permeation layer 18 obtained by dissolving or dispersing a compound, which becomes the ink permeation layer 18, such as the thermoplastic resin particles 26 such as polyethylene particles, a binder, or the like, in ion exchange water or the like, is prepared.

Additionally, first, the coating liquid for forming a protective layer 14 is applied to the surface of the support 12 and is dried to form the protective layer 14. The coating liquid may be applied by a known method such as a bar coating method, a die coating method, and dipping (dip coating). In addition, the coating liquid may be dried by a known method according to the coating liquid such as heating and drying using hot air or a heater. In this regard, both the image receiving layer 16 and the ink permeation layer 18 are similar.

Next, the coating liquid for forming an image receiving layer 16 is applied to the surface of the formed protective layer 14 and dried to form the image receiving layer 16.

Further, the coating liquid for forming an ink permeation layer 18 is applied to the surface of the formed image receiving layer 16 and dried and the ink permeation layer 18 is formed. Thus, the transfer film 10 is prepared.

An image forming method according to an embodiment of the present invention is provided for forming an image by an ink jet method on an article such as the printing material P using such a transfer film 10 according to the embodiment of the present invention.

In the image forming method according to the embodiment of the present invention, the printing material P is not particularly limited and various recording media such as a CD and a DVD, and various known articles such as a resin molded article, a metal product, and a product formed of paper such as coated cardboard or corrugated board can be used. Among these, a card-like material such as a ride card for a train, a bus, and the like, a credit card, an electronic money card, an identification (ID) card, a card key, and various point cards are suitably used as the printing material P.

In the image forming method according to the embodiment of the present invention, first, printing is performed from the jetting surface 24 of the ink permeation layer 18 of the transfer film 10 by an ink jet method (printing step). The ink jetted to the jetting surface 24 of the ink permeation layer 18 permeates into the ink permeation layer 18 by passing through the gaps of the thermoplastic resin particles 26 and reaches the image receiving layer 16, the ink is fixed by the fixing agent of the image receiving layer 16, and the image formed by the ink is held in the image receiving layer 16.

After printing is performed on the transfer film 10 by the ink jet method, in the same manner as shown in FIG. 7 described above, the ink permeation layer 18 is caused to abut on an article which becomes the printing material P, and the printing material P and the transfer film 10 are laminated. Next, if necessary, while pressing the printing material P and the transfer film 10, for example, by heating from the support 12, the transfer film 10 (ink permeation layer 18) and the printing material P are heated and caused to adhere to each other (heating bonding or heating adhesion) (adhering step).

After the transfer film 10 and the printing material P are caused to adhere to each other, the support 12 is peeled off from the transfer film 10 and the transfer laminate is transferred to the surface of the printing material P to form an image printed on the printing material P by the ink jet method. As described above, the transfer laminate is the laminate including the ink permeation layer 18, the image receiving layer 16, and the protective layer 14.

As described above, in the transfer film 10 according to the embodiment of the present invention, the protective layer 14 is a layer containing a polymer having a glass transition temperature of 0° C. or higher and CNF. Therefore, according to the image forming method according to according to the embodiment of the present invention using the transfer film 10 according to the embodiment of the present invention, after the transfer film 10 is caused to adhere to the printing material P, the support 12 can be peeled off from the protective layer 14 with good peelability and an image can be formed on the printing material P by the ink jet method by transferring the transfer laminate to the surface of the printing material P.

Here, in the image forming method according to the embodiment of the present invention, for example, as shown in FIG. 7, an image may be formed on the printing material P using the transfer film in a cut-sheet form. However, a long transfer film is used and an image is preferably formed on the printing material P by the transfer film, while moving the transfer film and the printing material P in the longitudinal direction of the transfer film at the same speed.

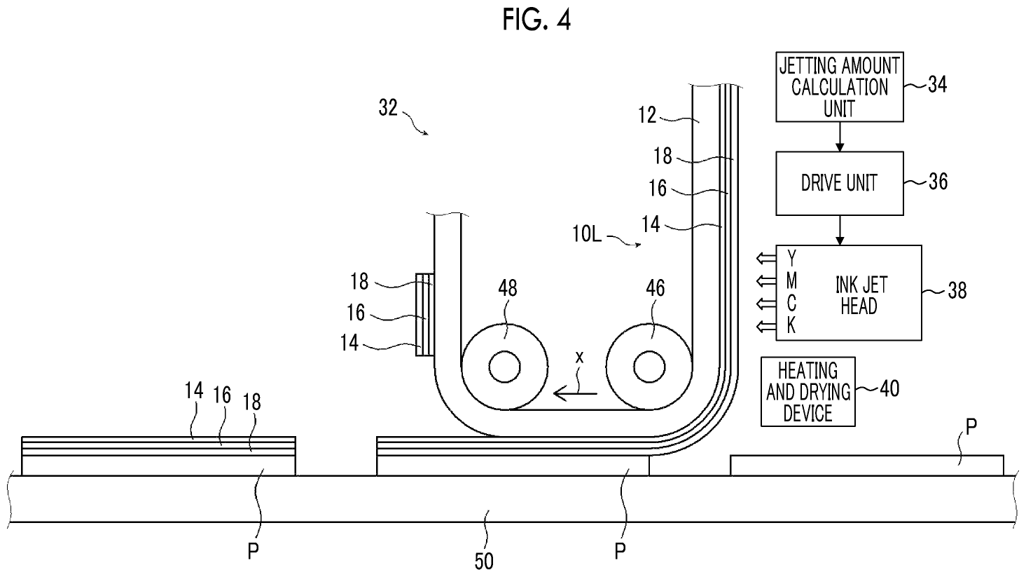

FIG. 4 is a view conceptually showing an example of an image forming apparatus for carrying out an image forming method using such a long transfer film.

An image forming apparatus 32 shown in FIG. 4 is provided for forming an image on a card-like printing material P using a long transfer film 10L.

The image forming apparatus 32 has a jetting amount calculation unit 34, a drive unit 36, an ink jet head 38, a heating and drying device 40, a heating roller 46, a peeling roller 48, and moving means 50.

The image forming apparatus 32 adopts a so-called roll-to-roll method. That is, the long transfer film 10L is sent out from a film roll (not shown) formed by winding the transfer film 10L into a roll shape, while being transported in the longitudinal direction by a predetermined transport path passing through the heating roller 46 and the peeling roller 48, the transfer film is subjected to printing and transfer to the printing material P (image formation), and then the support 12 is wound onto a collecting roll (not shown) in a roll shape.

In addition to the support 12, the ink permeation layer 18, the image receiving layer 16, and the protective layer 14 (that is, the transfer film), which are not subjected to transfer, are partially wound onto the collecting roll.

The width of the transfer film 10L may be the same as the size of the printing material P, may be larger than the size of the printing material P, or may be smaller than the size of the printing material P.

On the other hand, the printing material P is placed on the moving means 50 and is transported in synchronization with the transport of the transfer film 10L in the transport direction of the transfer film 10L (in the direction of the arrow x in the drawing), that is, in the direction the same as the longitudinal direction of the transfer film 10L in a region corresponding to the space between the heating roller 46 and the peeling roller 48. That is, the printing material P is transported in the same direction as the direction of the transfer film 10L at the same speed in the region corresponding to the heating roller 46 and the peeling roller 48.

The moving means 50 has various available moving means of known articles. As an example, a flat bed, a roller conveyor, a belt conveyor, and the like, on which a printing material P is placed and moved, are exemplified.

In the image forming apparatus 32 shown in the drawing, the transfer film 10L is guided by the heating roller 46 and the peeling roller 48, is transported toward the moving means 50, that is, the printing material P (approaching region), is then transported in the same direction as the direction of the transport of the printing material P by the moving means 50, and is then transported in a direction in which the transfer film is separated from the moving means 50, that is, the printing material P (separating region) along a transport path having a substantially U shape.

The transfer film 10L is transported in the transport path having a substantially U shape by causing the support 12 to abut on the heating roller 46 and the peeling roller 48. In addition, the ink jet head 38, the heating and drying device 40, and the moving means 50 are disposed so as to face the ink permeation layer 18 in the transport path having a substantially U shape.

The jetting amount calculation unit 34 is a unit that calculates the amount of ink to be jetted to the transfer film 10L and supplies the calculated amount to the drive unit 36. The drive unit 36 is a unit that applies a drive voltage to the ink jet head 38 according to the amount of ink calculated by the jetting amount calculation unit 34 and jets the ink from the ink jet head 38.

The ink jet head 38 is a known ink jet head having a nozzle row that jets a yellow (Y) ink, a nozzle row that jets a magenta (M) ink, a nozzle row that jets a cyan (C) ink, and a nozzle row that jets a black (K) ink.

Accordingly, the ink jet head 38 may be a line head long in a direction perpendicular to the transport direction of the transfer film 10L or may be a carriage type head which moves in a direction perpendicular to the transport direction of the transfer film 10L. In addition to the ink jet head for printing a color image as shown in the example in the drawing, for example, the ink jet head may be an ink jet head for printing a monochrome image, may be a head for printing the same color image, or may be an ink jet head for jetting C, M, and Y inks.

As described above, while the transfer film 10L sent out from the film roll is transported in the direction toward the heating roller 46, that is, toward the printing material P, printing is performed on the transfer film by the ink jet head 38 on the upstream side of the heating roller 46.

On the transfer film 10L printed by the ink jet head 38, the jetted ink is heated and dried between the ink jet head 38 and the heating roller 46 by the heating and drying device 40.

Next, the transport direction of the transfer film 10L is changed by the heating roller 46 and the transfer film is heated from the support 12. The transfer film 10L is then transported in the same direction as the moving direction of the printing material P by the moving means 50. Then, the transport direction thereof is changed by the peeling roller 48 and the transfer film is transported in the direction in which the transfer film is separated from the moving means 50, that is, the printing material P and reaches the collecting roll.

Here, in the region corresponding to the transport path of the transfer film 10L between the heating roller 46 and the peeling roller 48, the moving means 50 is provided in a state in which the placement surface of the printing material P faces the transfer film 10L and the placement surface of the printing material P is separated from the transfer film 10L by a predetermined distance. The separation distance between the placement surface of the printing material P and the transfer film 10L between the heating roller 46 and the peeling roller 48 is slightly smaller than the thickness of the card-like printing material P.

As described above, the printing material P is placed on the moving means 50 and the moving means 50 moves at the same speed in the same direction as the direction of the transfer film 10L.

Accordingly, in a case where the printing material P is transported by the moving means 50, first, the transfer film 10L (ink permeation layer 18) and the printing material P are caused to abut each other (laminated), pressed, and further heated by the heating roller 46. By this heating and pressing, an ink permeation layer 18 is heat and caused to adhere to the printing material P.

Thereafter, the transfer film 10L and the printing material P are transported between the heating roller 46 and the peeling roller 48 while being pressed.

In a case where the transfer film 10L reaches the peeling roller 48, the transport path is changed by the peeling roller 48 in a direction in which the transfer film is separated from the moving means 50, that is, the printing material P.

As described above, since the protective layer 14 contains the polymer having a glass transition temperature of 0° C. or higher and CNF in the transfer film 10L according to the embodiment of the present invention, the peelability between the support 12 and the protective layer 14 is good. Therefore, by the heating and adhesion of the ink permeation layer 18 and the printing material P and the change of the transport path of the transfer film 10L, the support 12 is peeled off from the protective layer 14 and the transfer laminate is transferred to the printing material P and only the support 12 is guided by the peeling roller 48 to be transported onto the collecting roll.

Further, in a case where the rear end portion of the printing material P in the transport direction reaches the peeling roller 48, the transfer film 10L (ink permeation layer 18) is not caused to adhere to the printing material P. That is, in the transfer film 10L, the force for peeling the support 12 and the protective layer 14 is applied. In addition, as described above, in the transfer film 10L, since the protective layer 14 contains the polymer having a glass transition temperature of 0° C. higher and CNF, the peelability between the support 12 and the protective layer 14 is excellent.

Therefore, the transfer film 10L transported by the peeling roller 48 in a direction away from the moving means 50, that is, the printing material P is broken at the rear end portion, which is not caused to adhere to the printing material P, in the transport direction of the printing material P, and the transfer laminate is transferred onto the surface of the printing material P to form an image on the printing material P.

In the image formation on the printing material P, it is needless to say that the printing timing is controlled at the printing by the ink jet head 38 such that the printing region on the transfer film 10L matches with the abutting region of the transfer film 10L and the printing material P.

As described above, in the image forming method according to the embodiment of the present invention using the transfer film 10L (transfer film 10) according to the embodiment of the present invention, the support 12 can be peeled off from the protective layer 14 with good peelability after the transfer film 10L is caused to adhere to the printing material P, and an image can be formed on the printing material P by the ink jet method by transferring the transfer laminate (the laminate including the ink permeation layer 18, the image receiving layer 16, and the protective layer 14) to the surface of the printing material P.

In addition, since the protective layer 14 which becomes the observation surface (surface) of the image contains CNF, interference fringes generated in a case where the image held by the image receiving layer 16 of the transfer laminate transferred to the printing material P is observed can be reduced.

In addition, in the transfer film 10L according to the embodiment of the present invention, the protective layer 14 is formed on the surface of the support 12 formed of a resin film or the like, and finally, the support 12 is peeled off from the protective layer 14. Therefore, the surface of the support 12 formed of a resin film or the like having high smoothness is transferred to the surface of the protective layer 14 and the protective layer 14 has a good surface state. As a result, according to the transfer film 10L according to the embodiment of the present invention, it is possible to transfer a high quality image having a good surface state and high glossiness to the printing material P.

Further, the transfer film 10L according to the embodiment of the present invention has the ink permeation layer 18 separately from the image receiving layer 16, and the laminate including the ink permeation layer 18, the image receiving layer 16, and the protective layer 14 is caused to adhere to the printing material P by the ink permeation layer 18. Therefore, the image receiving layer 16 which holds the image is not affected by adhesion, and as a result, a high quality image can be formed to the printing material P.

As described above, in the transfer film 10 according to the embodiment of the present invention, any of the white inorganic pigment, the organic resin fine particles, and the light scattering particles may be mixed into the ink permeation layer 18 to form the ink permeation layer 18 as a white layer or a light scattering layer.

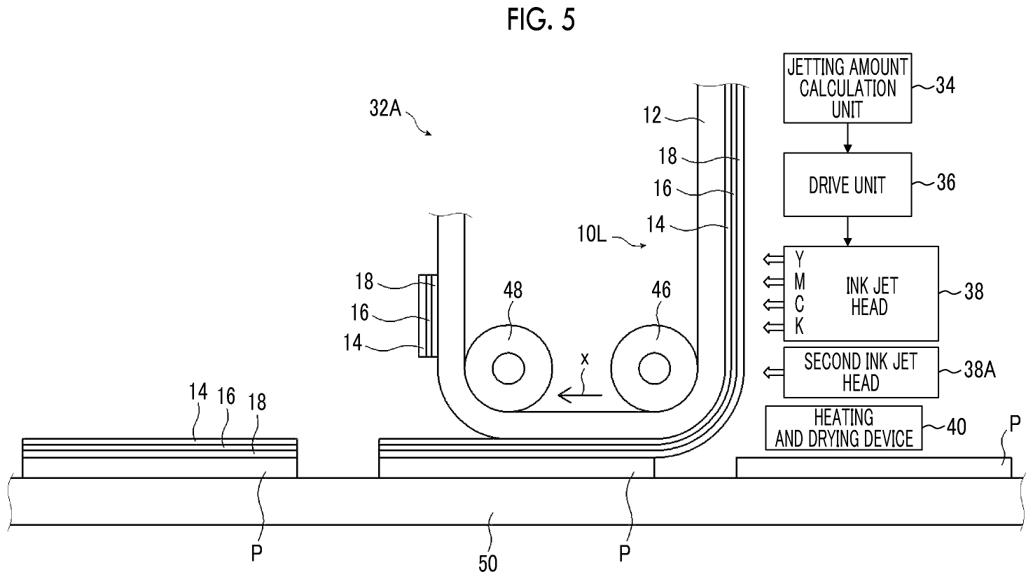

In this case, as shown in the image forming apparatus 32A conceptually shown in FIG. 5, a second ink jet head 38A which jets one or more of the inorganic pigment, the organic fine resin particles, and the light scattering particles is provided on the downstream side of the ink jet head 38 and on the upstream side of the adhering position, and jets one or more of the inorganic pigment, the organic fine resin particles, and the light scattering particles to the necessary region of the ink permeation layer 18. That is, printing may be performed on the ink permeation layer 18 by one or more of the inorganic pigment, the organic fine resin particles, and the light scattering particles.

In addition, similarly to the ink jet head 38, a known ink jet head can be used for the second ink jet head 38A.

According to this image forming apparatus 32A (image forming method), the white layer and/or the light scattering layer is provided only in the necessary region in the surface direction of the transfer film 10 and the optical properties of the printing material P may remain in regions other than the above region.

That is, according to this image forming apparatus 32A, in a case where the printing material P is transparent, the transparent state is kept in regions except for the region where the inorganic pigment or the like is jetted, and in a case where the printing material P is a colored object, the color of the printing material P remains in regions except for the region where the inorganic pigment or the like is jetted.

In the image forming method according to the embodiment of the present invention, the image formation result may be fed back by detecting the image formed on the printing material P.

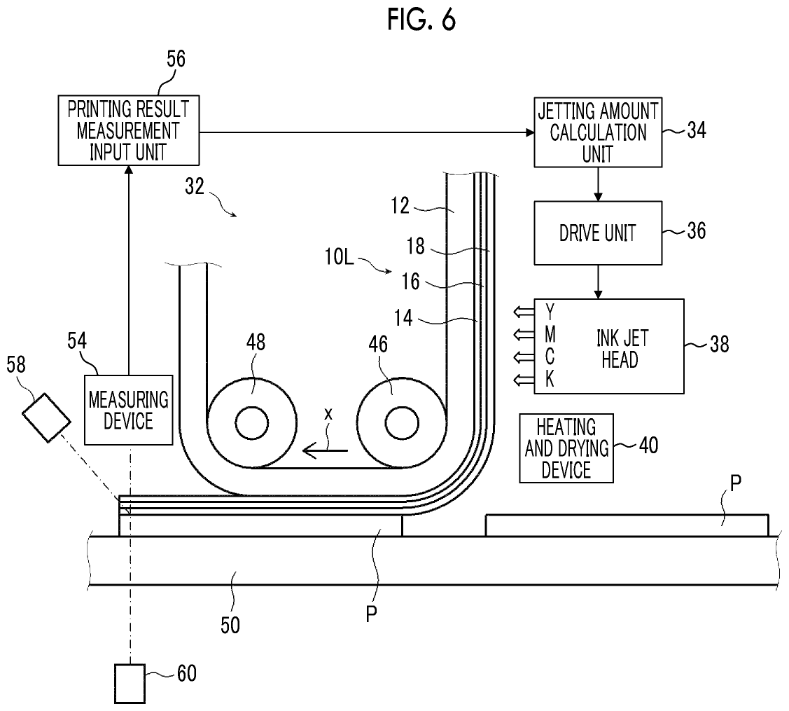

That is, as conceptually shown by exemplifying the image forming apparatus 32 in FIG. 6, in the image forming apparatus shown in FIG. 4, a measuring device 54 is disposed on the downstream side of the peeling roller 48, a printing result measurement input unit 56 is connected to the measuring device 54, and the printing result measurement input unit 56 is connected to the jetting amount calculation unit 34.

The measuring device 54 measures light that is emitted by a light source 58 disposed on the side of the printing material P close to the transferred surface and is reflected on the image receiving layer 16. In addition, in a case where the printing material P is transparent, a light source 60 may be provided so as to sandwich the printing material P with the measuring device 54 and the light passing through the printing material P, the ink permeation layer 18, the image receiving layer 16, and the protective layer 14 may be measured by the measuring device 54.

The measured value obtained by the measuring device 54 is input to the printing result measurement input unit 56 and the image formed on the printing material P is detected. The image detection result by the printing result measurement input unit 56 is supplied to the jetting amount calculation unit 34.

The jetting amount calculation unit 34 obtains a corrected ink jetting amount for each region of the printing material P based on the image detection result supplied from the printing result measurement input unit 56 so as to realize the target color development. In accordance with the corrected ink jetting amount, the drive unit 36 drives the ink jet head 38 so that printing on the transfer film is performed.

Based on the ink jetting amount corrected by detecting the image formed on the printing material P and feeding back the image detection result in this manner, by performing printing on the transfer film 10L, even in a case where the initial ink jetting amount is poor, or even in a case where the physical properties of the ink and the transfer film 10L and the like are changed, it is possible to effectively suppress variation in color development.

This configuration can also be used in an image forming apparatus 32A shown in FIG. 5.

Hereinafter, the transfer film and the image forming method according to the embodiments of the present invention have been described in detail. However, the present invention is not limited to the examples and of course, various improvements and modifications may be made without departing from the gist of the present invention.

### EXAMPLES

Hereinafter, the present invention will be described in more detail by giving specific examples of the present invention.

### Example 1

<Support>

A PET film having a width of 1000 mm, a thickness of 100 μm, and a length of 100 m (COSMOSHINE A4100, manufactured by Toyobo Co., Ltd.) was used as the support 12.

<Protective Layer>

<<Preparation of CNF Dispersion Liquid>>

To 60 g of LEO crystal I-2SP (CNF aqueous dispersion, manufactured by Dai-ichi Kogyo Seiyaku Co., Ltd., average fiber diameter: 4 nm, CNF concentration: 2%), 540 g of ion exchange water was added.

The CNF aqueous dispersion was stirred for 5 minutes at 3000 revolutions per minute (rpm) using an emulsifying disperser (TK ROBOMICS manufactured by PRIMIX Corporation) to prepare a CNF dispersion liquid (CNF concentration: 0.2% by mass).

<<Preparation of Coating Liquid for Forming Protective Layer>>

The following materials were stirred and mixed to prepare a coating liquid for forming a protective layer.

| | | |
|---|---|---|
| Ion exchange water | 458 | parts by mass |
| CNF dispersion liquid | 132 | parts by mass |
| Urethane-based resin emulsion (SUPERFLEX | 400 | parts by weight |
| 170, manufactured by Dai-ichi Kogyo Seiyaku | | |
| Co., Ltd., polymer concentration: 33% by | | |
| mass, glass transition temperature of polymer: | | |
| 75° C., refractive index of polymer: 1.52) | | |
| 10% by mass polyoxyethylene lauryl ether | 10 | parts by mass |
| aqueous solution (EMULGEN 109P, surfactant, | | |
| manufactured by Kao Corporation) | | |

<<Formation of Protective Layer>>

The coating liquid for forming a protective layer was applied to the highly smooth surface of the support 12 using a #20 wire bar in a coating amount of 35 g/m², and dried at 100° C. for 2 minutes. Thus, the protective layer 14 was formed on the surface of the support 12. The thickness of the formed protective layer 14 was 4 μm.

<Image Receiving Layer>

<<Preparation of Dispersion Liquid>>

A mixed liquid having the following composition was prepared.

| | |
|---|---|
| Vapor phase method silica particles | 5.7 parts by mass |
| (AEROSIL300SF75, manufactured by | |
| Nippon Aerosil Co., Ltd.) | |
| Ion exchange water | 22.7 parts by mass |
| Dispersant | 0.5 parts by mass |
| (SHAROL DC-902P, manufactured by | |
| Dai-ichi Kogyo Seiyaku Co., Ltd., | |
| concentration: 51.5% by mass, | |
| charge density: 6.6 meq/g) | |
| Zirconyl acetate | 0.3 parts by mass |
| (ZIRCOSOL ZA-30, manufactured by | |
| Dai-ichi Kigenso Kagaku Kogyo Co., Ltd.) | |

The mixed liquid was dispersed using a liquid-liquid collision type disperser (ULTIMAIZER, manufactured by Sugino Machine Limited) to prepare an intermediate dispersion liquid. The prepared intermediate dispersion liquid was heated at 45° C. and maintained at the temperature for 20 hours. Thus, a dispersion liquid was prepared.

<<Preparation of Coating Liquid for Forming Image Receiving Layer>>

The following materials were added to the prepared dispersion liquid and stirred and mixed to prepare a coating liquid for forming an image receiving layer.

| | |
|---|---|
| 5% by mass boric acid aqueous solution | 4.2 parts by mass |
| 8.1% by mass polyvinyl alcohol solution | 16.5 parts by mass |
| (PVA235: 7.0% by mass, PVA505: 1.1% by mass, | |
| manufactured by KURARAY Co., Ltd.) | |
| Diethylene glycol monobutyl ether | 0.4 parts by mass |
| (BUTYCENOL 20P, manufactured by | |
| Kyowa Hakko Chemicals Co., Ltd.) | |
| 10% by mass polyoxyethylene lauryl ether | 0.4 parts by mass |
| aqueous solution (EMULGEN 109P, surfactant, | |
| manufactured by Kao Corporation) | |
| Ion exchange water | 5.9 parts by mass |

<<Preparation of In-Line Liquid>>

The following materials were mixed to prepare an in-line liquid.

| | |
|---|---|
| Highly basic aluminum chloride | 3.7 parts by mass |
| (ALPINE 83, manufactured by TAIMEI Chemical | |
| Co., Ltd) | |
| Ion exchange water | 6.3 parts by mass |

<<Preparation of Liquid Containing Basic Compound>>

The following materials were mixed to prepare a liquid containing a basic compound.

| | |
|---|---|
| Boric acid | 0.7 parts by mass |
| Ammonium carbonate (reagent grade | 5 parts by mass |
| 1, manufactured by KANTO KAGAKU) | |
| Zirconium compound | 0.3 parts by mass |
| (ZIRCOSOL AC-7, manufactured by Dai-ichi | |
| Kigenso Kagaku Kogyo Co., Ltd.) | |
| Ion exchange water | 93.4 parts by mass |
| 10% by mass polyoxyethylene lauryl ether | 0.6 parts by mass |
| aqueous solution (EMULGEN 109P, surfactant, | |
| manufactured by Kao Corporation) | |

<<Formation of Image Receiving Layer>>

The coating liquid for forming an image receiving layer and the in-line liquid were in-line mixed and the mixture was applied to the surface of the protective layer 14 previously formed using an extrusion die coater.

Specifically, the coating liquid for forming an image receiving layer and the in-line liquid were in-line mixed such that coating amount of the coating liquid was 90.5 g/m² and the coating amount of the in-line liquid was 7.4 g/m², and the mixture was applied.

The formed coating layer (coating film) was dried with a hot air dryer at 80° C. (wind speed 5 m/sec) until the solid content concentration reached 36% by mass. The coating layer showed constant rate drying during this period.

Immediately after drying the coating layer until the concentration of solid contents reached 36% by mass, the coating layer was immersed in the liquid containing a basic compound for 3 seconds, and 13 g/m² of the liquid containing a basic compound was applied to the coating layer having a concentration of solid contents of 36% by mass.

Further, the liquid was dried at 72° C. for 10 minutes and thus the image receiving layer 16 was formed on the surface of the protective layer 14. The thickness of the formed image receiving layer 16 is 20 μm.

<Ink Permeation Layer>

<<Preparation of Coating Liquid for Forming Ink Permeation Layer>>

The following materials were mixed to prepare a coating liquid for forming an ink permeation layer.

| | |
|---|---|
| Ion exchange water | 900 parts by mass |
| Carboxylated styrene butadiene latex | 50 parts by mass |
| (Nipol LX433C, manufactured by Zeon | |
| Corporation) | |
| 10% by mass polyoxyethylene lauryl ether | 50 parts by mass |
| aqueous solution (EMULGEN 109P, surfactant, | |
| manufactured by Kao Corporation) | |

<<Formation of Ink Permeation Layer>>

The coating liquid for forming an ink permeation layer was applied to the surface of the image receiving layer 16 previously formed using a #8 wire bar and dried at 40° C. for 10 minutes. Thus, the ink permeation layer 18 was formed on the surface of the image receiving layer 16 to prepare the transfer film 10. The thickness of the formed ink permeation layer was 0.3 μm.

### Example 2

<<Preparation of Coating Liquid for Forming Protective Layer>>

The following materials were stirred and mixed to prepare a coating liquid for forming a protective layer.

| | | |
|---|---|---|
| Ion exchange water | 557 | parts by mass |
| CNF dispersion liquid | 33 | parts by mass |
| Urethane-based resin emulsion | 400 | parts by weight |
| (SUPERFLEX 170, manufactured by | | |
| Dai-ichi Kogyo Seiyaku Co., Ltd., | | |
| polymer concentration: 33% by mass, | | |
| glass transition temperature of | | |
| polymer: 75° C., refractive index of | | |
| polymer: 1.52) | | |
| 10% by mass polyoxyethylene lauryl ether | 10 | parts by mass |
| aqueous solution (EMULGEN 109P, surfactant, | | |
| manufactured by Kao Corporation) | | |

A transfer film was prepared in the same manner as in Example 1 except that the protective layer 14 was formed using this coating liquid. The thickness of the formed protective layer 14 was 4 μm.

### Example 3

<<Preparation of Coating Liquid for Forming Protective Layer>>

The following materials were stirred and mixed to prepare a coating liquid for forming a protective layer.

| | | |
|---|---|---|
| Ion exchange water | 524 | parts by mass |
| CNF dispersion liquid | 66 | parts by mass |
| Urethane-based resin emulsion | 400 | parts by weight |
| (SUPERFLEX 170, manufactured by Dai-ichi | | |
| Kogyo Seiyaku Co., Ltd., polymer concentration: | | |
| 33% by mass, glass transition temperature of | | |
| polymer: 75° C., refractive index of | | |
| polymer: 1.52) | | |
| 10% by mass polyoxyethylene lauryl ether | 10 | parts by mass |
| aqueous solution (EMULGEN 109P, surfactant, | | |
| manufactured by Kao Corporation) | | |

A transfer film was prepared in the same manner as in Example 1 except that the protective layer 14 was formed using this coating liquid. The thickness of the formed protective layer 14 was 4 μm.

### Example 4

<<Preparation of Coating Liquid for Forming Protective Layer>>

The following materials were stirred and mixed to prepare a coating liquid for forming a protective layer.

| | | |
|---|---|---|
| CNF dispersion liquid | 593 | parts by mass |
| Urethane-based resin emulsion (SUPERFLEX | 397 | parts by weight |
| 170, manufactured by Dai-ichi Kogyo Seiyaku | | |
| Co., Ltd., polymer concentration: 33% by mass, | | |
| glass transition temperature of polymer: 75° C., | | |
| refractive index of polymer: 1.52) | | |
| 10% by mass polyoxyethylene lauryl ether | 10 | parts by mass |
| aqueous solution (EMULGEN 109P, surfactant, | | |
| manufactured by Kao Corporation) | | |

A transfer film was prepared in the same manner as in Example 1 except that the protective layer 14 was formed using this coating liquid. The thickness of the formed protective layer 14 was 4 μm.

### Example 5

<<Preparation of Coating Liquid for Forming Protective Layer>>

The following materials were stirred and mixed to prepare a coating liquid for forming a protective layer.

| | | |
|---|---|---|
| Ion exchange water | 460 | parts by mass |
| Kaolin dispersion liquid | 7 | parts by mass |
| (KAOBRIGHT 90, manufactured by THIELE, | | |
| kaolin concentration: 40% by mass) | | |
| CNF dispersion liquid | 132 | parts by mass |
| Urethane-based resin emulsion | 392 | parts by weight |
| (SUPERFLEX 170, manufactured by Dai-ichi | | |
| Kogyo Seiyaku Co., Ltd., polymer concentration: | | |
| 33% by mass, glass transition temperature of | | |
| polymer: 75° C., refractive index of | | |
| polymer: 1.52) | | |
| 10% by mass polyoxyethylene lauryl ether | 10 | parts by mass |
| aqueous solution (EMULGEN 109P, surfactant, | | |
| manufactured by Kao Corporation) | | |

A transfer film was prepared in the same manner as in Example 1 except that the protective layer 14 was formed using this coating liquid. The thickness of the formed protective layer 14 was 4 μm.

### Example 6

<<Preparation of Coating Liquid for Forming Protective Layer>>

The following materials were stirred and mixed to prepare a coating liquid for forming a protective layer.

| | | |
|---|---|---|
| Ion exchange water | 462 | parts by mass |
| Kaolin dispersion liquid | 17 | parts by mass |
| (KAOBRIGHT 90, manufactured by THIELE, | | |
| kaolin concentration: 40% by mass) | | |
| CNF dispersion liquid | 132 | parts by mass |
| Urethane-based resin emulsion | 380 | parts by weight |
| (SUPERFLEX 170, manufactured by Dai-ichi | | |
| Kogyo Seiyaku Co., Ltd., polymer concentration: | | |
| 33% by mass, glass transition temperature of | | |
| polymer: 75° C., refractive index of | | |
| polymer: 1.52) | | |
| 10% by mass polyoxyethylene lauryl ether | 10 | parts by mass |
| aqueous solution (EMULGEN 109P, surfactant, | | |
| manufactured by Kao Corporation) | | |

A transfer film was prepared in the same manner as in Example 1 except that the protective layer 14 was formed using this coating liquid. The thickness of the formed protective layer 14 was 4 μm.

### Example 7

<<Preparation of Coating Liquid for Forming Protective Layer>>

The following materials were stirred and mixed to prepare a coating liquid for forming a protective layer.

| | | |
|---|---|---|
| Ion exchange water | 465 | parts by mass |
| Kaolin dispersion liquid | 33 | parts by mass |
| (KAOBRIGHT 90, manufactured by THIELE, | | |
| kaolin concentration: 40% by mass) | | |
| CNF dispersion liquid | 132 | parts by mass |
| Urethane-based resin emulsion (SUPERFLEX | 360 | parts by weight |
| 170, manufactured by Dai-ichi Kogyo Seiyaku | | |
| Co., Ltd., polymer concentration: 33% by mass, | | |
| glass transition temperature of polymer: | | |
| 75° C., refractive index of polymer: 1.52) | | |
| 10% by mass polyoxyethylene lauryl ether | 10 | parts by mass |
| aqueous solution (EMULGEN 109P, surfactant, | | |
| manufactured by Kao Corporation) | | |

A transfer film was prepared in the same manner as in Example 1 except that the protective layer 14 was formed using this coating liquid. The thickness of the formed protective layer 14 was 4 μm.

### Example 8

<<Preparation of Coating Liquid for Forming Protective Layer>>

The following materials were stirred and mixed to prepare a coating liquid for forming a protective layer.

| | | |
|---|---|---|
| Ion exchange water | 472 | parts by mass |
| Kaolin dispersion liquid | 66 | parts by mass |
| (KAOBRIGHT 90, manufactured by THIELE, | | |
| kaolin concentration: 40% by mass) | | |
| CNF dispersion liquid | 132 | parts by mass |
| Urethane-based resin emulsion | 320 | parts by weight |
| (SUPERFLEX 170, manufactured by Dai-ichi | | |
| Kogyo Seiyaku Co., Ltd., polymer concentration: | | |
| 33% by mass, glass transition temperature of | | |
| polymer: 75° C., refractive index of | | |
| polymer: 1.52) | | |
| 10% by mass polyoxyethylene lauryl ether | 10 | parts by mass |
| aqueous solution (EMULGEN 109P, surfactant, | | |
| manufactured by Kao Corporation) | | |

A transfer film was prepared in the same manner as in Example 1 except that the protective layer 14 was formed using this coating liquid. The thickness of the formed protective layer 14 was 4 μm.

### Example 9

<<Preparation of Coating Liquid for Forming Protective Layer>>

The following materials were stirred and mixed to prepare a coating liquid for forming a protective layer.

| | | |
|---|---|---|
| Ion exchange water | 397 | parts by mass |
| Aluminum hydroxide dispersion liquid | 17 | parts by mass |
| (HIGILITE H42, manufactured by Showa Denko | | |
| K. K., aluminum hydroxide concentration: | | |
| 40% by mass) | | |
| CNF dispersion liquid | 132 | parts by mass |
| Urethane-based resin emulsion | 444 | parts by weight |
| (SUPERFLEX 870, manufactured by Dai-ichi | | |
| Kogyo Seiyaku Co., Ltd., polymer concentration: | | |
| 30% by mass, glass transition temperature of | | |
| polymer: 78° C., refractive index of | | |
| polymer: 1.58) | | |
| 10% by mass polyoxyethylene lauryl ether | 10 | parts by mass |
| aqueous solution (EMULGEN 109P, surfactant, | | |
| manufactured by Kao Corporation) | | |

A transfer film was prepared in the same manner as in Example 1 except that the protective layer 14 was formed using this coating liquid. The thickness of the formed protective layer 14 was 4 μm.

### Comparative Example 1

<<Preparation of Coating Liquid for Forming Protective Layer>>

The following materials were stirred and mixed to prepare a coating liquid for forming a protective layer.

| | | |
|---|---|---|
| Ion exchange water | 590 | parts by mass |
| Urethane-based resin emulsion | 400 | parts by weight |
| (SUPERFLEX 170, manufactured by Dai-ichi | | |
| Kogyo Seiyaku Co., Ltd., polymer concentration: | | |
| 33% by mass, glass transition temperature of | | |
| polymer: 75° C., refractive index of | | |
| polymer: 1.52) | | |
| 10% by mass polyoxyethylene lauryl ether | 10 | parts by mass |
| aqueous solution (EMULGEN 109P, surfactant, | | |
| manufactured by Kao Corporation) | | |

A transfer film was prepared in the same manner as in Example 1 except that the protective layer 14 was formed using this coating liquid. The thickness of the formed protective layer 14 was 4 μm.

### Comparative Example 2

<<Preparation of Coating Liquid for Forming Protective Layer>>

The following materials were stirred and mixed to prepare a coating liquid for forming a protective layer.

| | |
|---|---|
| Ion exchange water | 700 parts by mass |
| Polyolefin | 290 parts by mass |
| (polyolefin aqueous dispersion, particle | |
| diameter: 0.5 μm, CHEMIPEARL S300, | |
| manufactured by Mitsui Chemicals, Inc., | |
| polymer concentration: 35% by mass, | |
| polymer glass transition temperature: −20° C. | |
| or lower, refractive index of polymer: 1.48) | |
| 10% by mass aqueous surfactant solution | 10 parts by mass |
| (polyoxyethylene lauryl ether, EMULGEN | |
| 109P, manufactured by Kao Corporation) | |

A transfer film was prepared in the same manner as in Example 1 except that the protective layer 14 was formed using this coating liquid. The thickness of the formed protective layer 14 was 3 μm.

[Evaluation]

The transfer films 10 of Examples 1 to 9 and Comparative Examples 1 and 2 thus prepared were evaluated for peelability and interference fringes.

<Peelability>

Seven colors of yellow, magenta, cyan, blue, green, red, and gray, and white and black stripe patterns were printed on each of the prepared transfer films 10 using an ink jet printer, from the ink permeation layer 18. Next, the transfer film 10 was cut into a size of 65×100 mm.

As the printing material P, a PET-G card having a thickness of 0.76 mm and a size of 54×86 mm was laminated at the center of the surface of the cut transfer film 10 close to the ink permeation layer 18.

This laminate was heat-pressed by being sandwiched and transported by a pair of rollers of a silicone rubber transfer roll having a roll surface heated to 120° C. and a support roll, and the transfer film 10 (ink permeation layer 18) and the card were heated and caused to adhere to each other. The linear pressure of heat-pressing was 1.5 kg/cm and the transport speed was 0.6 m/min.

Next, the support 12 was peeled off and the peelability was evaluated. The evaluation is as follows.

A: A case where the support could be clearly peeled off without unpeeled portions and forming the wing attachment.

B: A case where a small wing attachment was observed but the support could be clearly peeled off without unpeeled portions.

C: A case where at least one of a small unpeeled portion of the support which does not cause a problem on quality or a small wing attachment which does not cause a problem on quality was formed.

D: A case where at least one of an unpeeled portion of the support which causes a problem on quality or a small wing attachment which causes a problem on quality was formed.

<Interference Fringes>

The laminate (transfer laminate) including the ink permeation layer 18, the image receiving layer 16, and the protective layer 14, which was prepared in the evaluation of peelability and transferred to a card and from which the support 12 was peeled off, was visually observed from the protective layer 14 side under three-wavelength fluorescent light, and the generation of interference fringes was visually evaluated. The evaluation is as follows.

A: Interference fringes are not noticeable.

B: Interference fringes are slightly concerned.

C: Interference fringes are concerned.

D: Interference fringes are noticeable.

In Comparative Example 2, the interference fringes could not be evaluated since the support 12 could not be appropriately peeled off.

The results are shown in the following table.

TABLE 1

| | Protective layer | | | | | | |
|---|---|---|---|---|---|---|---|
| | Polymer | | CNF | Inorganic particles | | Evaluation | |
| | | Tg | Content | | Content | | Interference |
| | Kind | [° C.] | [% by mass] | Kind | [% by mass] | Peelability | fringes |
| Example 1 | Urethane-based resin (SUPER FLEX 170) | 75 | 0.2 | — | — | B | B |
| Example 2 | Urethane-based resin (SUPER FLEX 170) | 75 | 0.05 | — | — | C | C |
| Example 3 | Urethane-based resin (SUPER FLEX 170) | 75 | 0.1 | — | — | B | B |
| Example 4 | Urethane-based resin (SUPER FLEX 170) | 75 | 0.9 | — | — | A | A |
| Example 5 | Urethane-based resin (SUPER FLEX 170) | 75 | 0.2 | Kaolin | 2 | A | A |
| Example 6 | Urethane-based resin (SUPER FLEX 170) | 75 | 0.2 | Kaolin | 5 | A | A |
| Example 7 | Urethane-based resin (SUPER FLEX 170) | 75 | 0.2 | Kaolin | 10 | A | A |
| Example 8 | Urethane-based resin (SUPER FLEX 170) | 75 | 0.2 | Kaolin | 20 | A | A |
| Example 9 | Urethane-based resin (SUPER FLEX 870) | 78 | 0.2 | Aluminum | 5 | A | A |
| | | | | hydroxide | | | |
| Comparative | Urethane-based resin (SUPER FLEX 170) | 75 | — | — | — | C | D |
| example 1 | | | | | | | |
| Comparative | Polyolefin (CHEMIPEARL S300) | −20 or | — | — | — | D | — |
| example 2 | | lower | | | | | |

As shown in Table 1, in the transfer film 10 according to the embodiment of the present invention containing the polymer having a glass transition temperature (Tg) of 0° C. or higher and CNF, the peelability between the protective layer 14 and the support 12 is good and few interference fringes are generated. Particularly, in Examples 1 and 3 to 9 in which the protective layer 14 contains 0.06% by mass or more of CNF, interference fringes are suitably reduced. Further, in Examples 5 to 9 containing the inorganic particles, interference fringes are more suitably reduced. In addition, as shown in Examples 1 to 4, as the content of CNF in the protective layer increases, the peelability with the support 12 is satisfactory.

On the other hand, in Comparative Example 1 in which the protective layer 14 contains the polymer having a glass transition temperature of 0° C. or higher but does not contain CNF, although the peelability is good, interference fringes are noticeable. In addition, in Comparative Example 2 in which the protective layer 14 does not contain a polymer having a glass transition temperature of 0° C. or higher and CNF, there is no peelability.

From the above results, the effects of the present invention are obvious.

The present invention can be suitably used for image formation on a member not having an ink receiving capacity such as a resin product, a metal product, a coated cardboard product, a corrugated cardboard product, and the like

### EXPLANATION OF REFERENCES

10: transfer film
12, 102: support
14: protective layer
16: image receiving layer
18: ink permeation layer
20: ink receiving particle
24: jetting surface
26: thermoplastic resin particle
28: tackifier particle
32, 32A: image forming apparatus
34: jetting amount calculation unit
36: drive unit
38: ink jet head
38A: second ink jet head
40: heating and drying device
46: heating roller
48: peeling roller
50: moving means
54: measuring device
56: printing result measurement input unit
58, 60: light source
100: laminate
100a: extra laminate
P: printing material

What is claimed is:

1. A transfer film comprising:
a support;
a protective layer that is formed on one surface of the support;
an image receiving layer that is formed on a surface of the protective layer; and
an ink permeation layer that is formed on a surface of the image receiving layer and has voids for allowing permeation of an ink,
wherein the protective layer contains a polymer having a glass transition temperature of 0° C. or higher and a cellulose nanofiber.

2. The transfer film according to claim 1,
wherein an average fiber diameter of the cellulose nanofiber is 50 nm or less.

3. The transfer film according to claim 1,
wherein a content of the cellulose nanofiber in the protective layer is 0.06% by mass or more.

4. The transfer film according to claim 1,
wherein the protective layer further contains inorganic particles.

5. An image forming method comprising:
a printing step of performing printing on the transfer film according to claim 1 from the ink permeation layer by an ink jet method;
an adhering step of causing the ink permeation layer of the transfer film subjected to printing to abut on a printing material and heating and causing the transfer film to adhere to the printing material; and
a peeling step of peeling off the support from the transfer film adhering to the printing material.

6. The image forming method according to claim 5,
wherein the transfer film is long, and
the adhering step and the peeling step are performed while the long transfer film and the printing material are being transported in a longitudinal direction of the long transfer film at a same speed.

7. The image forming method according to claim 6,
wherein a transport path of the long transfer film has an approaching region which is directed in a direction in which the transfer film approaches the printing material, and a separating region which is provided on a downstream side of the approaching region and is directed in a direction in which the transfer film is separated from the printing material,
the adhering step is performed between the approaching region and the separating region, and
the peeling step is performed in the separating region.

8. The image forming method according to claim 6,
wherein the printing step is performed on an upstream side from a region in the adhering step in a transport direction of the long transfer film, while the long transfer film is being transported in the longitudinal direction.

9. The image forming method according to claim 6,
wherein printing is performed on the ink permeation layer using one or more of a white inorganic pigment, organic resin fine particles, and light scattering particles by an ink jet method on a downstream side from a region in the printing step in the transport direction of the long transfer film and on the upstream side from a region in the adhering step, while the long transfer film is being transported in the longitudinal direction.
